(19) United States
(12) Patent Application Publication
(10) Pub. No.: US 2024/0194860 A1
(43) Pub. Date: Jun. 13, 2024

(54) CATHODE ACTIVE MATERIAL FOR LITHIUM SECONDARY BATTERY AND LITHIUM SECONDARY BATTERY INCLUDING THE SAME

(71) Applicants: SK INNOVATION CO., LTD., Seoul (KR); SK ON CO., LTD., Seoul (KR)

(72) Inventors: Yeong Bin YOO, Daejeon (KR); Sung Soon PARK, Daejeon (KR); Keum Jung YOON, Daejeon (KR); Jong Hwa KIM, Daejeon (KR); Dong Il JANG, Daejeon (KR)

(21) Appl. No.: 18/510,647

(22) Filed: Nov. 16, 2023

(30) Foreign Application Priority Data
Dec. 8, 2022 (KR) 10-2022-0170599

(51) Int. Cl. H01M 4/36; C01G 53/00; H01M 4/38; H01M 4/485; H01M 4/505; H01M 4/525; H01M 4/58; H01M 10/052

(52) U.S. Cl. CPC H01M 4/366; C01G 53/50; H01M 4/38; H01M 4/485; H01M 4/505; H01M 4/525; H01M 4/5825; H01M 10/052; H01M 2004/028

(57) ABSTRACT

A cathode active material for a lithium secondary battery includes a lithium-transition metal oxide particle containing phosphorus introduced into the particle, and a coating formed on at least a portion of a surface of the lithium-transition metal oxide particle. The coating includes a phosphorus-containing compound. A content of phosphorus introduced into the lithium-transition metal oxide particle is in a range from 15 wt % to 30 wt % based on a sum of a weight of phosphorus introduced into the lithium-transition metal oxide particle and a weight of phosphorus contained in the coating.

### CROSS-REFERENCE TO RELATED APPLICATION AND CLAIM OF PRIORITY

This application claims priority to Korean Patent Application No. 10-2022-0170599 filed on Dec. 8, 2022 in the Korean Intellectual Property Office (KIPO), the entire disclosure of which is incorporated by reference herein.

### BACKGROUND

### 1. Field

The disclosure of this patent application relates to a cathode active material for a lithium secondary battery and a lithium secondary battery including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as an eco-friendly power source of an electric automobile, a hybrid vehicle, etc.

Examples of the secondary battery includes, e.g., a lithium secondary battery, a nickel-cadmium battery, a nickel-hydrogen battery, etc. The lithium secondary battery is being actively developed due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape for accommodating the electrode assembly and the electrolyte.

A lithium-transition metal oxide may be used as a cathode active material for the lithium secondary battery. The lithium-transition metal oxide may include, e.g., a nickel-based lithium metal oxide.

As an application range of the lithium secondary batteries is being expanded, higher capacity and longer life-span are required while maintaining operational stability. A side reaction between the lithium-transition metal oxide and the electrolyte or structural deformation of the lithium-transition metal oxide may occur to degrade the operational stability of the lithium secondary battery.

### SUMMARY

According to an aspect of the present disclosure, there is provided a cathode active material for a lithium secondary battery having improved operational stability and electrochemical property.

According to an aspect of the present disclosure, there is provided a lithium secondary battery having improved operational stability and electrochemical property.

A cathode active material for a lithium secondary includes a lithium-transition metal oxide particle containing phosphorus introduced into the particle, and a coating formed on at least a portion of a surface of the lithium-transition metal oxide particle. The coating includes a phosphorus-containing compound. A content of phosphorus introduced into the lithium-transition metal oxide particle is in a range from 15 wt % to 30 wt % based on a sum of a weight of phosphorus introduced into the lithium-transition metal oxide particle and a weight of phosphorus contained in the coating.

In some embodiments, the phosphorus-containing compound may include LiₓP_{y}O_{z} (1≤x≤4, 1≤y≤4, 0≤z≤7).

In some embodiments, the sum of the weight of phosphorus introduced into the lithium-transition metal oxide particle and the weight of phosphorus included in the coating may be measured by an inductively coupled plasma emission spectrometry (ICP-OES) analysis of a solution in which the cathode active material is dissolved in an acid solvent.

In some embodiments, the weight of phosphorus included in the coating is measured by the ICP-OES analysis of a solution in which the cathode active material is dissolved in deionized water (DIW) or an organic solvent.

In some embodiments, the weight of phosphorus introduced into the lithium-transition metal oxide particle may be in a range from 250 ppm to 700 ppm relative to the total weight of the cathode active material.

In some embodiments, the sum of the weight of phosphorus introduced into the lithium-transition metal oxide particle and the weight of phosphorus included in the coating may be in a range from 1,000 ppm to 3,500 ppm relative to the total weight of the cathode active material.

In some embodiments, the lithium-transition metal oxide particle may further contain boron, and the coating may further include a boron-containing compound.

In some embodiments, the boron-containing compound may include a lithium-boron oxide.

In some embodiments, a content of boron included in the lithium-transition metal oxide particle measured by an ICP-OES may be in a range from 5 wt % to 20 wt % based on a sum of a weight of boron included in the lithium-transition metal oxide particle and a weight of boron included in the coating.

In some embodiments, a boundary layer may be formed between the lithium-transition metal oxide particle and the coating. The boundary layer includes the phosphorus-containing compound.

In some embodiments, a weight of phosphorus included in the boundary layer may be smaller than the weight of phosphorus included in the coating.

A lithium secondary battery includes the cathode for a lithium secondary battery according to the above-described embodiments, and an anode facing the cathode.

In a method of preparing a cathode active material for a lithium secondary battery, a transition metal precursor, a lithium precursor and a phosphorus source are mixed to form a mixture. The mixture is fired to form a lithium-transition metal oxide particle containing phosphorus introduced into the particle and a coating formed on at least a portion of a surface of the lithium-transition metal oxide particle, the coating containing a phosphorus-containing compound. A content of phosphorus introduced into the lithium-transition metal oxide particle is in a range from 15 wt % to 30 wt % based on a sum of a weight of phosphorus introduced into the lithium-transition metal oxide particle and a weight of phosphorus contained in the coating measured by an ICP-OES analysis.

In some embodiments, the firing may be performed at a temperature of 600° C. to 900° C.

In some embodiments, a phosphorus content in the phosphorus source may be in a range from 1,500 ppm to 4,000 ppm based on a total weight of the cathode active material.

A cathode active material according to embodiments of the present disclosure includes a lithium-transition metal oxide particle and a coating formed on at least a portion of a surface of the lithium-transition metal oxide particle.

The lithium-transition metal oxide particle contain phosphorus (P) introduced into the particle. For example, phosphorus may be doped into a layered structure of lithium-transition metal oxide particle to improve structural stability of the cathode active material. Accordingly, life-span properties of the lithium secondary battery in a high-temperature environment may be improved.

The coating includes a phosphorus-containing compound. Thus, a side reaction between the lithium-transition metal oxide particle and an electrolyte may be suppressed and an ion conductivity of the cathode active material may be improved. Additionally, the lithium-transition metal oxide particle may be protected from moisture and/or HF damaging the surface of the lithium-transition metal oxide particle through the coating.

In example embodiments, a weight of phosphorus introduced into the lithium-transition metal oxide particle may be in a range from 15 wt % to 30 wt % based on a sum of the weight of phosphorus introduced into the lithium-transition metal oxide particle and the weight of phosphorus included in the coating. Within this range, phosphorus may be sufficiently doped into the lithium-transition metal oxide particle while sufficiently forming the coating containing the phosphorus-containing compound on the surface of the cathode active material. Accordingly, the structural stability and ionic conductivity of the cathode active material may be enhanced, and thus high-temperature life-span properties may be improved.

### BRIEF DESCRIPTION OF THE DRAWINGS

FIGS. 1 and 2 are a schematic plan view and a schematic cross-sectional view, respectively, illustrating a lithium secondary battery in accordance with exemplary embodiments.

FIG. 3 is a graph obtained by measuring elemental phosphorus signals on surfaces of cathode active materials of Comparative Examples 1 and 2, and Examples 1, 3, 4 and 6 from an X-ray photoelectron spectrometer (XPS) analysis.

FIG. 4 is a graph showing differential capacity curves versus voltage (dQ/dV vs. V) in a formation charge/discharge step of lithium secondary batteries of Comparative Examples 1 and 2, and Examples 1, 3, 4 and 6.

### DETAILED DESCRIPTION OF THE EMBODIMENTS

According to embodiments of the present invention, a cathode active material for a lithium secondary battery including a lithium-transition metal oxide particle and a lithium secondary battery including the cathode active material are provided.

Hereinafter, example embodiments will be described in detail with reference to exemplary embodiments and the accompanying drawings. However, those skilled in the art will appreciate that such embodiments and drawings are provided to further understand the spirit of the present invention and do not limit subject matters to be protected as disclosed in the detailed description and appended claims.

In example embodiments, a cathode active material for a lithium secondary battery (hereinafter, that may be abbreviated as “cathode active material”) includes lithium-transition metal oxide particle and a coating formed on at least a portion of a surface of the lithium-transition metal oxide particle. For example, the cathode active material may include a plurality of the lithium-transition metal oxide particles, and the coating may be formed on a surface of each of the lithium-transition metal oxide particles.

In example embodiments, the lithium-transition metal oxide particle may serve as a compound capable of reversibly intercalating and de-intercalating lithium ions.

The lithium-transition metal oxide particle contains phosphorus (P) introduced into the particle. For example, phosphorus may be doped into a layered structure of the lithium-transition metal oxide particle to improve structural stability of the cathode active material. Accordingly, life-span properties of the lithium secondary battery in a high-temperature environment may be improved.

For example, the lithium-transition metal oxide particle may further include at least one of cobalt (Co) and manganese (Mn). In some embodiments, the cathode active material may include a Ni—Co—Mn (NCM)-based lithium oxide.

In some embodiments, the lithium-transition metal oxide particle may have a layered structure or a crystal structure represented by Chemical Formula 1 below.

LiₓNiₐM_{b}O_{2+y} [Chemical Formula 1]

In Chemical Formula 1, 0.9≤x≤1.2, 0.6≤a≤0.99, 0.01≤b≤0.4, and −0.5≤z≤0.1. As described above, M may include Co and/or Mn.

The chemical structure represented by Chemical Formula 1 indicates bonding relationships included in the crystal structure or the layered structure of the lithium-transition metal oxide particle, and is not intended to not exclude other additional elements. For example, M may include Co and/or Mn, and Co and Mn may serve as a main active element of the cathode active material. Chemical Formula 1 is provided to express the bonding relationships of the main active elements, and is to be understood as a formula allowing an introduction and a substitution of an additional element.

In an embodiment, an auxiliary element may be added to the main active element to enhance chemical stability of the cathode active material or the crystal structure/layered structure. The auxiliary element may be incorporated into the crystal structure/layered structure to form a bond, and Chemical Formula 1 is interpreted to include this structure.

The auxiliary elements may include at least one of, e.g., P, Na, Mg, Ca, Y, Ti, Hf, V, Nb, Ta, Cr, Mo, W, Fe, Cu, Ag, Zn, B, Al, Ga, C, Si, Sn, Sr, Ba, Ra and Zr. The auxiliary element may act as an auxiliary active element such as Al that contributes to the capacity/power of the cathode active material together with Co or Mn.

In example embodiments, the auxiliary element may include P in consideration of structural stability of the cathode active material.

For example, the cathode active material or the lithium-transition metal oxide particle may have the layered structure or the crystal structure represented by Chemical Formula 1-1 below.

LiₓNiₐM1_{b1}M2_{b2}O_{2+z} [Chemical Formula 1-1]

In Chemical Formula 1-1, M1 may include Co and/or Mn. M2 may include the above-described auxiliary element. In Chemical Formula 1-1, 0.9≤x≤1.2, 0.6≤a≤0.99, 0.01≤b1+b2≤0.4, and −0.5≤z≤0.1.

The cathode active material may further include a coating element or a doping element. For example, elements substantially the same as or similar to the above-mentioned auxiliary elements may be used as the coating element or the doping element. For example, one of the above elements or a combination of two or more from the above elements may be used as the coating element or the doping element.

The coating element or the doping element may be present on a surface of the lithium-transition metal oxide particle, or may penetrate through the surface of the lithium-transition metal oxide particle to be included into the bonding structure represented by Chemical Formula 1 or Chemical Formula 1-1.

In example embodiments, a coating is formed on at least a portion of the surface of the lithium-transition metal oxide particle.

In some embodiments, a coating may be formed entirely on the surface of the lithium-transition metal oxide particle.

For example, the coating may include a phosphorus-containing compound. Accordingly, a side reaction between the lithium-transition metal oxide particle and the electrolyte may be suppressed, and an ion conductivity of the cathode active material may be improved. Additionally, the lithium-transition metal oxide particle may be protected from moisture and/or HF damaging the surface of the lithium-transition metal oxide particle by the coating.

In some embodiments, the phosphorus containing compound may include lithium phosphate. For example, lithium remaining on the surface of the lithium-transition metal oxide particle may react with phosphorus to form lithium phosphate. Thus, life-span properties of the cathode active material may be improved.

In some embodiments, the phosphorus-containing compound may include LiₓP_{y}O_{z} (1≤x≤4, 1y≤4, 0≤z≤7). For example, the phosphorus-containing compound may include at least one selected from the group consisting of Li₃PO₄, LiPO₃, Li₄P₂O₇, LiP and Li₃P.

In example embodiments, a content of phosphorus introduced into the lithium-transition metal oxide particle may be in a range from 15 weight percent (wt %) to 30 wt % based on a sum of a weight of phosphorus introduced into an inside of the lithium-transition metal oxide particle and a weight of phosphorus included in the coating. Within this range, phosphorus may be sufficiently doped into the lithium-transition metal oxide particle while sufficiently forming the coating containing the phosphorus-containing compound on the surface of the cathode active material. Accordingly, structural stability and ionic conductivity of the cathode active material may be improved, and thus high-temperature life-span properties may be improved.

If the content of phosphorus introduced into the lithium-transition metal oxide particles is less than 15 wt % based on the sum of the weight of phosphorus introduced into the lithium-transition metal oxide particle and the weight of phosphorus contained in the coating, 85 wt % of a total weight of phosphorus may not be doped into the lithium-transition metal oxide particle and may remain on the surface of the particle to form an excessively large amount of the coating. Accordingly, the ionic conductivity of the surface of the lithium-transition metal oxide particle may be lowered.

If the content of phosphorus introduced into the lithium-transition metal oxide particles exceeds 30 wt % based on the sum of the weight of phosphorus introduced into the lithium-transition metal oxide particles and the weight of phosphorus included in the coating, the phosphorus content remaining in the coating may be less than 70 wt % based on the total weight of phosphorus. In this case, the coating including the LiₓP_{y}O_{z} (1≤x≤4, 1≤y≤4, 0≤z≤7) compound may not be sufficiently formed. Accordingly, the side reaction between the cathode active material and the electrolyte may be increased.

An amount of phosphorus included in the coating based on the sum of the weight of phosphorus included in the lithium-transition metal oxide particle and the weight of phosphorus included in the coating may be in a range from 70 wt % to 85 wt %. Within the above range, the amount of phosphorus remaining in the coating among the total weight of phosphorus may be properly maintained, so that phosphorus may be sufficiently doped at an inside of the particle while sufficiently forming the coating.

The sum of the weight of phosphorus included in the lithium-transition metal oxide particle and the weight of phosphorus included in the coating (e.g., the total weight of phosphorus included in the cathode active material) can be determined by an inductively coupled plasma optical emission spectroscopy (ICP-OES).

For example, a cathode active material including the lithium-transition metal oxide particles into which phosphorus is introduced and the coating may be prepared.

A solution obtained by treating the prepared cathode active material with an acid solvent is analyzed by the ICP-OES to measure the sum (A) of the weight of phosphorus introduced into the lithium-transition metal oxide particles and the weight of phosphorus included in the coating.

For example, the acid solvent may include a strong acid solvent such as hydrochloric acid, nitric acid and/or sulfuric acid. In this case, the lithium-transition metal oxide particles and the coating of the cathode active material may be sufficiently dissolved so that the total weight of phosphorus included in the cathode active material can be measured.

In some embodiments, the weight of phosphorus included in the coating may be independently measured using the ICP-OES by analyzing the solution in which the prepared cathode active material is dissolved in deionized water (DIW) or an organic solvent.

For example, the prepared cathode active material may be dissolved in pure water or the organic solvent for about 1 hour to separate the solution into a solution layer and a precipitate.

The weight of phosphorus (B) contained in the coating may be independently measured by analyzing a solution obtained by acid-treating the solution layer by the ICP-OES. The acid treatment may be performed using the acid solvent described above.

The coating of the cathode active material is dissolved by using pure water or the organic solvent as a solvent, but the lithium-transition metal oxide particles are substantially insoluble and may remain as the precipitate. Accordingly, the weight of phosphorus included in the coating can be independently measured.

For example, the organic solvent may include an alcohol-based solvent such as ethanol and/or methanol.

For example, the weight of phosphorus introduced into the lithium-transition metal oxide particle (A-B) can be calculated by subtracting the weight of phosphorus (B) included in the coating from the sum (A) of the weight of phosphorus introduced into the lithium-transition metal oxide particle and the weight of phosphorus included in the coating measured by the above method.

In some embodiments, the weight of phosphorus introduced into the lithium-transition metal oxide particle may be in a range from 250 ppm to 700 ppm based on a total weight of the cathode active material. Within this range, capacity and power degradation due to an excessive phosphorus doping while sufficiently improving structural stability of the lithium-transition metal oxide particle.

For example, if the total weight of phosphorus included in the cathode active material (e.g., the sum of the weight of phosphorus introduced into the lithium-transition metal oxide particle and the weight of phosphorus included in the coating) is excessively increased, most of phosphorus included in the cathode active material may be included in the coating, and the weight of phosphorus introduced into the lithium-transition metal oxide particle may be reduced. Accordingly, the structural stability of the cathode active material may be deteriorated and the ionic conductivity at the cathode surface may be decreased due to the excessive formation of the coating.

In some embodiments, the sum of the weight of phosphorus introduced into the lithium-transition metal oxide particle and the weight of phosphorus included in the coating may be in a range from 1,000 ppm to 3,500 ppm based on the total weight of the cathode active material. Within the above range, an excessive reduction of a ratio of the weight of phosphorus introduced into the lithium-transition metal oxide particle relative to the total weight of phosphorus included in the cathode active material due to the excessive phosphorus content may be prevented while sufficiently performing the phosphorus coating and doping.

In some embodiments, the cathode active material may further include a boundary layer formed between the lithium-transition metal oxide particle and the coating. The boundary layer may include the above-described phosphorus-containing compound.

For example, the boundary layer may serve as a diffusion portion of the phosphorus-containing compound while further protecting the lithium-transition metal oxide particles together with the coating.

For example, a weight of phosphorus included in the boundary layer may be less than the weight of phosphorus included in the coating.

For example, the weight of phosphorus included in the boundary layer may be smaller than the weight of phosphorus introduced into the lithium-transition metal oxide particle.

In some embodiments, the lithium-transition metal oxide particle may further contain boron as an auxiliary element or doping element, and the coating may further contain a boron-containing compound. Accordingly, the structural stability and ionic conductivity of the cathode active material may be further improved.

In some embodiments, the boron-containing compound may include a lithium-boron oxide.

For example, the boron-containing compound may include at least one selected from the group consisting of Li₃BO₃, LiBO₂ and Li₂B₄O₇.

In some embodiments, a weight of boron included in the lithium-transition metal oxide particle measured by the ICP-OES may be in a range from 5 wt % to 20 wt % based on a sum of the weight of boron included in the lithium-transition metal oxide particle and the weight of boron included in the coating. Within this range, the lithium-transition metal oxide particle may be sufficiently doped with boron while sufficiently forming the coating containing the boron-containing compound on the surface of the cathode active material. Accordingly, the structural stability and ionic conductivity of the cathode active material may be improved, and thus high-temperature life-span properties may be improved.

Hereinafter, a method for manufacturing the cathode active material described above will be described.

In example embodiments, a transition metal precursor, a lithium precursor and a phosphorus source may be mixed to form a mixture (e.g., a primary mixture).

For example, the lithium-transition metal oxide particles may be formed by a reaction of a transition metal precursor and a lithium precursor. The transition metal precursor (e.g., a Ni—Co—Mn precursor) may be prepared through a co-precipitation reaction.

For example, the transition metal precursors may be prepared by the co-precipitation of metal salts. The metal salts may include a nickel salt, a manganese salt and a cobalt salt.

The nickel salt may include, e.g., at least one selected from the group consisting of nickel sulfate, nickel hydroxide, nickel nitrate, nickel acetate and a hydrate thereof.

The manganese salt may include, e.g., at least one selected from the group consisting of manganese sulfate, manganese acetate and a hydrate thereof.

The cobalt salt may include, e.g., at least one selected from the group consisting of cobalt sulfate, cobalt nitrate, cobalt carbonate and a hydrate thereof.

The metal salts may be mixed with a precipitating agent and/or a chelating agent in a ratio satisfying the content or concentration ratio of each metal described with reference to Chemical Formula 1 to form an aqueous solution. The transition metal precursor may be prepared by co-precipitating the aqueous solution in a reactor.

The precipitating agent may include an alkaline compound such as sodium hydroxide (NaOH), sodium carbonate (Na₂CO₃), etc. The chelating agent may include, e.g., ammonia water, ammonium carbonate, etc.

A temperature of the co-precipitation reaction may be controlled, e.g., in a range from about 40° C. to 60° C. A reaction time may be adjusted in a range from about 24 hours to 72 hours.

The lithium precursor may include, e.g., at least one selected from the group consisting of lithium carbonate, lithium nitrate, lithium acetate, lithium oxide and lithium hydroxide.

In some embodiments, the phosphorus source may include at least one selected from the group consisting of NH₄H₂PO₄, (NH₄)₂HPO₄, (NH₄)₃PO₄, Mg₃(PO₄)₂, AlPO₄, Co₃(PO₄)₂, (C₂H₅O)₂P(O)H, (C₄H₉O)₂P(O)OH, Ni₃(PO₄)₂, NaNH₄HPO₄, (NH₄)MgPO₄(6H2O), Na₂H₂P₂O₇, Na₄P₂O₇ and (NaPO₃)ₙ(n>O).

For example, a phosphorus content included in the phosphorus source may be adjusted within 1,500 ppm to 4,000 ppm based on a total weight of the cathode active material. Within this range, a sufficient amount of phosphorus may be included in the cathode active material.

In example embodiments, a mixture of the transition metal precursor, the lithium precursor and the phosphorus source may be fired (calcined) to from the cathode active material.

For example, phosphorus included in the phosphorus source may be doped into the lithium-transition metal oxide particle, and the coating may be formed on at least a portion of the surface of the lithium-transition metal oxide particle.

In some embodiments, the firing (calcination) may be performed at a temperature ranging from 600° C. to 900° C. Within this range, the phosphorus doping and the phosphorus-containing compound coating may be performed on the cathode active material while forming a layered structure of the lithium-transition metal oxide particles.

A weight of phosphorus introduced into the lithium-transition metal oxide particles of the prepared cathode active material is in a range from 15 wt % to 30 wt % based on a sum of the weight of phosphorus introduced into the lithium-transition metal oxide particle and a weight of phosphorus included in the coating measured by ICP-OES.

In some embodiments, the cathode active material and a boron source may be mixed to form a secondary mixture.

The secondary mixture may be fired (calcined) so that boron may be additionally doped and/or coated on the lithium-transition metal oxide particle.

For example, the firing (calcination) of the secondary mixture may be performed at a temperature ranging from 200° C. to 400° C. Within the above range, excessive capacity reduction of the cathode active material due to excessive introduction of boron into the lithium-transition metal oxide particle may be prevented.

For example, the firing of the second mixture may be performed at a temperature lower than that of the firing of the first mixture. Accordingly, the capacity degradation of the cathode active material may be prevented while doping and/or coating the lithium-transition metal oxide particle together with phosphorus and boron.

Through the multi-step firing process, the cathode active material doped and coated with phosphorus and doped and/or coated with boron may be provided. Through the doping and/or coating of boron, the high-temperature life-span enhancement from phosphorus may be further promoted.

For example, the boron source may include at least one selected from the group consisting of H₃BO₃, B₂O₃, C₆H₅B(OH)₂, (C₆H₅O)₃B, [CH₃(CH₂)₃O]₃B, C₁₃H₁₉BO₃, C₃H₉B₃O₆, (C₃H₇O)₃B, (NH₄)₂B₂O₇·4H₂O, (NH₄)B₅O₈·4H₂O and Na₂B₄O₇(10H₂O). Accordingly, boron may be further contained in the lithium-transition metal oxide particle, and the boron-containing compound may be included in the coating.

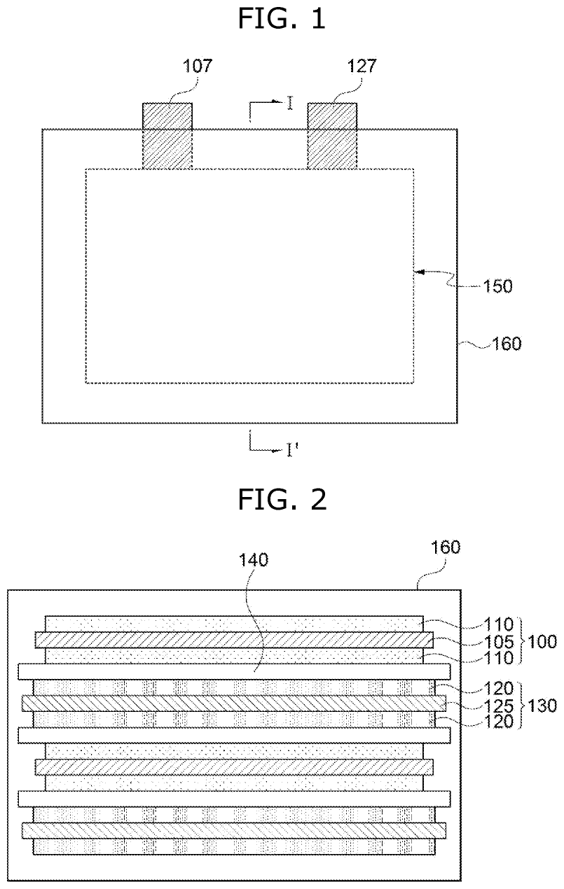

FIGS. 1 and 2 are a schematic plan view and a schematic cross-sectional view, respectively, illustrating a lithium secondary battery in accordance with exemplary embodiments. For example, FIG. 2 is a cross-sectional view taken along a line I-I′ of FIG. 1.

Referring to FIGS. 1 and 2, the lithium secondary battery may include a cathode 100 and an anode 130 facing the cathode 100.

The cathode 100 may include a cathode active material layer 110 formed by coating the above-described cathode active material on a cathode current collector 105.

For example, the cathode active material may be mixed and stirred in solvent with a binder, a conductive material and/or a dispersive agent to form the slurry. The slurry may be coated on at least one surface of the cathode current collector 105, and then dried and pressed to form the cathode 100.

A non-aqueous solvent may be used as the solvent. For example, N-methyl-2-pyrrolidone (NMP), dimethylformamide, dimethylacetamide, N,N-dimethylaminopropylamine, ethylene oxide, tetrahydrofuran, etc., may be used as the solvent.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer 110 may be reduced, and an amount of the cathode active material may be relatively increased. Thus, capacity and power of the secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 130 may include an anode current collector 125 and an anode active material layer 120 formed by coating an anode active material on at least one surface of the anode current collector 125.

The anode active material may include a material capable of adsorbing and ejecting lithium ions. For example, a carbon-based material such as a crystalline carbon, an amorphous carbon, a carbon complex or a carbon fiber, a lithium alloy, silicon or tin may be used as the anode active material.

The amorphous carbon may include, e.g., a hard carbon, cokes, a mesocarbon microbead (MCMB) fired at a temperature of 1500° C. or less, a mesophase pitch-based carbon fiber (MPCF), etc. The crystalline carbon may include a graphite-based material such as natural graphite, graphitized cokes, graphitized MCMB, graphitized MPCF, etc. The lithium alloy may further include aluminum, zinc, bismuth, cadmium, antimony, silicon, lead, tin, gallium, indium, etc.

The anode current collector 125 may include, e.g., gold, stainless steel, nickel, aluminum, titanium, copper, or an alloy thereof, and preferably may include copper or a copper alloy.

In some embodiments, a slurry may be prepared by mixing and stirring the anode active material with a binder, a conductive material and/or a dispersive agent in a solvent. The slurry may be coated on at least one surface of the anode current collector, and then dried and pressed to form the anode 130.

The binder and the conductive material substantially the same as or similar to those used for the cathode active material layer 110 may be used in the anode 130. In some embodiments, the binder for forming the anode 130 may include an aqueous binder such as styrene-butadiene rubber (SBR) for a compatibility with, e.g., the carbon-based active material, and carboxymethyl cellulose (CMC) may also be used as a thickener.

In some embodiments, a separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, etc. The separation layer 140 may also include a non-woven fabric formed from a glass fiber with a high melting point, a polyethylene terephthalate fiber, or the like.

In example embodiments, an electrode cell may be defined by the cathode 100, the anode 130 and the separation layer 140, and a plurality of the electrode cells may be stacked to form an electrode assembly 150 that may have e.g., a jelly roll shape. For example, the electrode assembly 150 may be formed by winding, stacking or folding of the separation layer 140.

The electrode assembly 150 may be accommodated together with an electrolyte in an case 160 to define the lithium secondary battery. In exemplary embodiments, a non-aqueous electrolyte may be used as the electrolyte.

The non-aqueous electrolyte may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc. These may be used alone or in a combination thereof.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

The lithium secondary battery may be manufactured in, e.g., a cylindrical shape using a can, a square shape, a pouch shape or a coin shape.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Evaluation Example 1

### Example 1

### (1) Preparation of Cathode Active Material

NiSO₄, CoSO₄ and MnSO₄ were mixed in a molar ratio of 0.94:0.05:0.01, respectively, using distilled water from which internal dissolved oxygen was removed by bubbling with N₂ for 24 hours. The solution was introduced into a reactor at 50° C. and co-precipitation was performed for 48 hours using NaOH and NH₃H₂O as a precipitating agent and a chelating agent, respectively, to obtain Ni_{0.94}Co_{0.05}Mn_{0.01}(OH)₂ as a transition metal precursor. The obtained precursor was dried at 80° C. for 12 hours and then redried at 110° C. for 12 hours.

Lithium hydroxide and the transition metal precursor were put into a dry mixer so that a molar ratio of Li:transition metal was 1.03:1, and (NH₄)₂HPO₄ was put into a dry mixer as a phosphorus source. An input amount of the phosphorus source was adjusted so that a weight of elemental phosphorus was 1,500 ppm based on a total weight of the cathode active material.

Lithium hydroxide, the transition metal precursor and (NH₄)₂HPO₄ were mixed uniformly in the dry mixer for 5 minutes. The mixture was put into a firing furnace and heated to 680° C. at a ramping rate of 2° C./min, and maintained at 680° C. for 10 hours. Oxygen was continuously passed at a flow rate of 20 L/min during the heating and maintenance.

Thereafter, natural cooling was performed to room temperature, and pulverization and classification were performed. From the above process, the cathode active material including lithium-transition metal oxide particles having a composition of LiNi_{0.94}Co_{0.05}Mn_{0.01}O₂ and doped with phosphorus and a coating formed on surfaces of the lithium-transition metal oxide particle was prepared.

### (2) Fabrication of Lithium Secondary Battery

A lithium secondary battery was manufactured using the prepared cathode active material.

Specifically, the prepared cathode active material, Denka Black as a conductive material and PVDF as a binder were mixed in a mass ratio of 93:5:2, respectively, to form a cathode slurry. The cathode slurry was coated on an aluminum current collector (thickness: 20 μm), vacuum dried at 100° C., and then pressed to from a cathode.

A 1.2 mm thick lithium metal (Li metal) was used as an anode.

The cathode and the anode prepared as described above were notched and stacked in a circular shape having diameters of Φ14 and Φ16, respectively, and a separator (polyethylene, thickness 13 μm) notched by a dimension of Φ19 was interposed between the cathode and the anode to form an electrode cell. The electrode cell was placed in a coin cell casing having a diameter of 20 mm and a height of 1.6 mm, an electrolyte was injected and assembled, and then aged for 12 hours or more so that the electrodes were impregnated with the electrolyte.

A 1M LiPF6 solution prepared using a mixed solvent of EC/EMC (30/70; volume ratio) was used as the electrolyte.

The secondary battery prepared as described above was subjected to a formation charging and discharging (charging condition CC-CV 0.1 C 4.3V 0.005 C CUT-OFF, discharging condition CC 0.1 C 3V CUT-OFF).

### Examples 2 to 6

Cathode active materials and lithium secondary batteries were prepared by the same method as that in Example 1, except that the input amount of the phosphorus source was adjusted so that a weight of elemental phosphorus based on a total weight of the cathode active material was adjusted as shown in Table 1.

### Comparative Example 1

A cathode active material and a lithium secondary battery were prepared by the same method as that in Example 1, except that the phosphorus source was not added.

### Comparative Examples 2 and 3

Cathode active materials and lithium secondary batteries were prepared by the same method as that in Example 1, except that the input amount of the phosphorus source was adjusted so that a weight of elemental phosphorus based on a total weight of the cathode active material was adjusted as shown in Table 1.

### Experimental Example

### (1) Measurement of Total Weight of Phosphorus (Measured P Content) Contained in Cathode Active Material

A sample solution was prepared by dissolving the cathode active material prepared according to each of Examples and Comparative Examples in a hydrochloric acid solvent. The sample solution was injected into an ICP-OES (5800 ICP-OES, Agilent Co.), and a total weight of elemental phosphorus included in the cathode active material (a sum of a weight of elemental phosphorus introduced into the lithium-transition metal oxide particle and a weight of elemental phosphorus included in the coating) based on the total weight of the cathode active material was measured.

### (2) Measurement of Content of Phosphorus and Boron Contained in Coating (Coating P, B Content)

A sample solution was prepared by dissolving the cathode active material prepared according to each of Examples and Comparative Examples in a pure water (DIW) solvent. The sample solution was allowed to stand for 1 hour to separate into a solution layer and a precipitate. The solution obtained by acid-treating the separated solution layer using a hydrochloric acid solvent was put into the ICP-OES to measure a weight of elemental phosphorus included in the coating based on the total weight of the cathode active material.

### (3) Calculation of Content of Phosphorus and Boron (Doped P, B Content) Contained in Lithium-Transition Metal Oxide Particle

The weight of elemental phosphorus introduced into the lithium-transition metal oxide particle was calculated by subtracting the weight of phosphorus contained in the coating measured in the above (2) from the total weight of phosphorus contained in the cathode active material measured in the above (1).

### (4) Measurement of Initial Discharge Capacity

Charging (CC-CV 0.1 C 4.3V 0.005 C CUT-OFF) and discharging (CC 0.1 C 3.0V CUT-OFF) of the lithium secondary battery according to each of Examples and Comparative Examples were performed once at room temperature (25° C.), and then a discharge capacity was measured and evaluated as an initial discharge capacity.

### (5) Evaluation on High Temperature Capacity Retention (45° C.)

The lithium secondary battery according to each of Examples and Comparative Examples was charged (CC/CV 0.5 C 4.3V 0.05 C CUT-OFF) and discharged (CC 1 C 3.0V CUT-OFF) repeatedly 150 times in a 45° C. chamber.

A capacity retention of the lithium secondary battery was calculated as a percentage by dividing a discharge capacity measured at the 150th cycle by a discharge capacity measured at the first cycle.

The input weight of elemental phosphorus based on the total weight of the cathode active material (input P content), the total weight of elemental phosphorus measured through the ICP-OES based on to the total weight of the cathode active material (measured P content), the weight of elemental phosphorus included in the coating measured through the ICP-OES based on the total weight of the cathode active material (coating P content), the weight of elemental phosphorus introduced into the lithium-transition metal oxide particle based on the total weight of the cathode active material (doping P content), and a percentage (doping ratio) of the weight of phosphorus introduced into the lithium-transition metal oxide particle based on the total weight of phosphorus are shown in Table 1 below.

TABLE 1

| | input P | measured P | coating P | doping P | doping ratio |
|---|---|---|---|---|---|
| No. | content (ppm) | content (ppm) | content (ppm) | content (ppm) | (wt %) |
| Example 1 | 1500 | 1236 | 872 | 364 | 29.4 |
| Example 2 | 2000 | 1742 | 1234 | 508 | 29.2 |
| Example 3 | 2500 | 2259 | 1710 | 549 | 24.3 |
| Example 4 | 3200 | 2809 | 2152 | 657 | 23.4 |
| Example 5 | 1000 | 863 | 617 | 246 | 28.5 |
| Example 6 | 4000 | 3552 | 3012 | 540 | 15.2 |
| Comparative | 0 | — | — | — | — |
| Example 1 | | | | | |
| Comparative | 700 | 626 | 422 | 204 | 32.6 |
| Example 2 | | | | | |
| Comparative | 4300 | 3844 | 3289 | 555 | 14.4 |
| Example 3 | | | | | |

The initial discharge capacity and the high-temperature capacity retention of the lithium secondary battery according to each of Examples and Comparative Examples are shown in Table 2 below.

TABLE 2

| | initial discharge | high temperature |
|---|---|---|
| | capacity | capacity retention |
| No. | (mAh/g) | (%, 150 cyc) |
| Example 1 | 228.5 | 74% |
| Example 2 | 227.4 | 76% |
| Example 3 | 226.3 | 79% |
| Example 4 | 223.9 | 80% |
| Example 5 | 228.8 | 69% |
| Example 6 | 221.3 | 81% |
| Comparative | 229.7 | 61% |
| Example 1 | | |
| Comparative | 229.1 | 63% |
| Example 2 | | |
| Comparative | 217.4 | 78% |
| Example 3 | | |

Referring to Tables 1 and 2, in Examples having a doping ratio of 15 wt % to 30 wt %, the high-temperature capacity retention was improved compared to those from Comparative Examples 1 and 2.

In Comparative Example 3, the coating content of phosphorus was excessively high, and the ionic conductivity of the surface of the cathode active material was excessively reduced. Accordingly, the initial discharge capacity was explicitly reduced.

In Example 5, the measured content of elemental phosphorus was less than 1,000 ppm and the doping P content was less than 250 ppm based on the total weight of the cathode active material. Accordingly, structural stability of the lithium-transition metal oxide particles was relatively lowered, and the high-temperature capacity retention was lowered relatively to those from other Examples.

In Example 6, the measured content of elemental phosphorus exceeded 3,500 ppm based on the total weight of the cathode active material, and the coating P content was increased compared to that in Example 4. Accordingly, the side reaction on the surface of the cathode active material was reduced, and the high-temperature capacity retention was further improved.

In Example 6, the doping ratio was decreased and the coating content was increased, and the ion conductivity of the surface of the lithium-transition metal oxide particle was relatively decreased, and the initial capacity was decreased compared to those from other Examples.

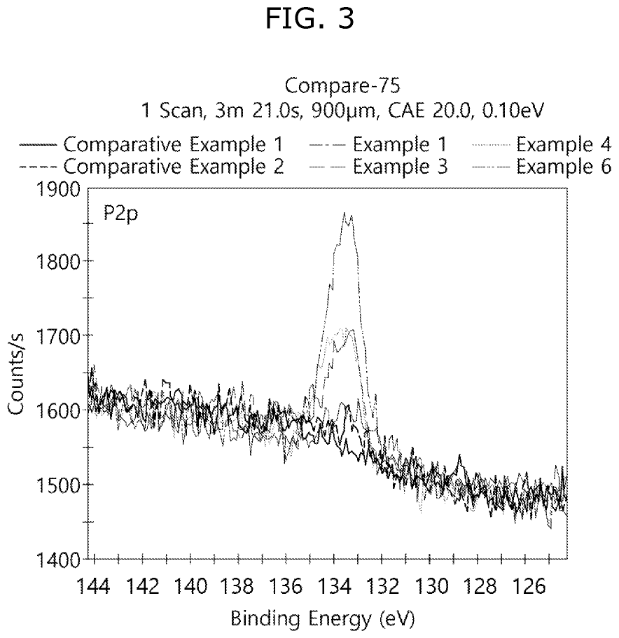

FIG. 3 is a graph obtained by measuring elemental phosphorus signals on surfaces of cathode active materials of Comparative Examples 1 and 2, and Examples 1, 3, 4 and 6 from an X-ray photoelectron spectrometer (XPS) analysis.

The XPS analysis was performed under the following conditions.
1) X-ray type: Source—Al Ka, Beam size 50 μm
2) Analyzer: CAE Mode
3) Number of scans: 2 (survey scan), 10-50 (Narrow Scan)
4) Pass energy: 150 eV (survey scan), 20 eV (narrow scan)

Referring to FIG. 3, in Comparative Example 1 where no phosphorus source was added, no phosphorus peak was detected in the XPS analysis.

In Comparative Example 2, the phosphorus source was added, but the phosphorus content coated on the surface was less than 1,000 ppm, and a trace amount of elemental phosphorus peak was observed.

The surfaces of the cathode active materials of Examples 3, 4 and 6 were coated with 1,500 ppm or more of phosphorus. Accordingly, a LiₓP_{y}O_{z} (1≤x≤4, 1≤y≤4, 0≤z≤7) compound was sufficiently formed on the surface of the lithium-transition metal oxide particle, and the P(2p) peak was clearly observed around 134 eV in the XPS analysis.

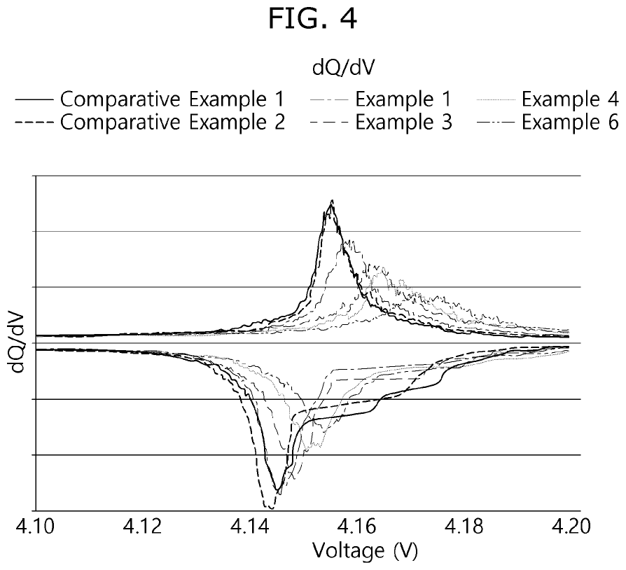

FIG. 4 is a graph showing differential capacity curves versus voltage (dQ/dV vs. V) in a formation charge/discharge step of lithium secondary batteries of Comparative Examples 1 and 2, and Examples 1, 3, 4 and 6.

Specifically, FIG. 4 is a graph setting an x-axis as a voltage and a y-axis as a differential value of a capacity versus the voltage (dQ/dV) after measuring a voltage and capacity during the formation chemical charging and discharging of the lithium secondary batteries of Comparative Examples 1 and 2 and Examples 1, 3, 4, and 6.

For example, a high-Ni cathode active material (e.g., a cathode active material having a Ni concentration or molar ratio of 0.8 or more) may show a transition peak (H2-H3 transition peak) from an H2 phase to an H3 phase around 4.10 V to 4.20 V. As the H2-H3 transition peak is present in a lower voltage range, unstable structural change may occur in an earlier phase.

Referring to FIG. 4, in Comparative Examples 1 and 2 where phosphorus was not doped or the weight of phosphorus introduced into the lithium-transition metal oxide particle was less than 250 ppm, the H2-H3 transition peak was observed in the lowest voltage band during charging (4.156V), and structural stability of the cathode active material was deteriorated.

In Examples 1, 3, 4 and 6 where the weight of phosphorus introduced into the lithium-transition metal oxide particle was 250 ppm or more, as the phosphorus content became greater, the voltage band in which phase transition occurred was also higher. Thus, structural stability of the cathode active material was improved. In Examples 1, 3, 4 and 6, as the phosphorus content became greater, a difference between a voltage band where a charge peak appeared and a voltage band a discharge peak appeared was decreased. Accordingly, reversibility of the phase transition of the cathode active material was obtained.

### Evaluation Example 2

### Example 7

Lithium-transition metal oxide particles in which phosphorus was introduced into the surface and at an inside of the particles were prepared by the same method as that in Example 2.

Thereafter, the lithium-transition metal oxide particles into which phosphorus was introduced and H₃BO₃ were uniformly mixed in a dry mixer for 3 minutes.

An input amount of H₃BO₃ was adjusted so that a weight of elemental boron was 1,000 ppm based on a total weight of the cathode active material. The mixture was put into a firing furnace and heated to 300° C. at a ramping rate of 2° C./min, and maintained at 300° C. for 10 hours (second firing). Oxygen was continuously passed at a flow rate of 20 L/min during the heating and maintenance. After the firing, natural cooling was performed to room temperature, and classification was performed.

From the above process, a cathode active material including the lithium-transition metal oxide particles having a composition of LiNi_{0.94}Co_{0.05}Mn_{0.01}O₂ and doped with phosphorus and boron, and a coating formed on surfaces of the lithium-transition metal oxide particles was prepared.

A lithium secondary battery was fabricated by the same method as that in Example 1, except that the above-prepared cathode active material was used.

### (1) Measurement of Total Weight of Phosphorus and Boron Contained in the Cathode Active Material (Measured P/B Content)

Sample solutions were prepared by dissolving the cathode active materials prepared according to Examples 2 and 7 in a hydrochloric acid solvent. The sample solution was injected into an ICP-OES, and a total weight of elemental phosphorus contained in the cathode active material (a sum of a weight of elemental phosphorus introduced into lithium-transition metal oxide particles and a weight of elemental phosphorus included in the coating) based on a total weight of the cathode active material, and a total weight of elemental boron included in the cathode active material based on the total weight of the cathode active material (a sum of a weight of elemental boron introduced into the lithium-transition metal oxide particle and a weight of elemental boron included in the coating) were measured.

### (2) Measurement of Weight of Phosphorus Contained in Coating (Coating P/B Content)

Sample solutions were prepared by dissolving the cathode active materials prepared according to Examples 2 and 7 in pure water (DIW) solvent. The sample solution was put into the ICP-OES to measure weights of elemental boron and elemental phosphorus included in the coating based on the total weight of the cathode active material.

### (3) Calculation of Phosphorus Weight (Doping P/B Content) Included in Lithium-Transition Metal Oxide Particle

A weight of elemental phosphorus introduced into the lithium-transition metal oxide particle was calculated by subtracting the weight of phosphorus contained in the coating measured in the above (2) from the total weight of phosphorus contained in the cathode active material measured in the above (1).

A weight of elemental boron introduced into the lithium-transition metal oxide particle was calculated by subtracting the weight of boron included in the coating measured in the above (2) from the total weight of boron included in the cathode active material measured in the above (1).

### (4) Measurement of Initial Discharge Capacity

The lithium secondary batteries prepared according to Examples 2 and 7 were charged (CC-CV 0.1 C 4.3V 0.005 C CUT-OFF) and discharged (CC 0.1 C 3.0V CUT-OFF) at room temperature (25° C.) twice and a discharge capacity was measured and evaluated as an initial discharge capacity.

### (5) Evaluation of High Temperature Capacity Retention (45° C.)

The lithium secondary batteries prepared according to Examples 2 and 7 were repeatedly charged (CC-CV 0.5 C 4.3V 0.05 C CUT-OFF) and discharged (CC 1 C 3.0V CUT-OFF) 150 times in a 45° C. chamber.

A capacity retention rate of each lithium secondary battery was calculated as a percentage by dividing a discharge capacity measured at the 150th cycle by a discharge capacity measured at the first discharge.

The input weight of elemental phosphorus and boron based on the total weight of the cathode active material (input P/B content), the total weight of elemental phosphorus and boron measured through the ICP-OES based on the total weight of cathode active material (measured P/B content), the weights of phosphorus and boron elements included in the coating measured by the ICP-OES based on the total weight of the active material (coating P/B content), the weights of phosphorus and boron elements introduced into the lithium-transition metal oxide particle based on the total weight of the cathode active material (doped P/B content), and the percentage of the weight of phosphorus/boron introduced into the lithium-transition metal oxide particles relative to the total weight of phosphorus/boron included in the cathode active material (doping ratio) are shown in Table 3 below.

TABLE 3

| | | | measured | | coating | | doping | | | |
|---|---|---|---|---|---|---|---|---|---|---|
| | input content | | content | | content | | content | | doping ratio | |
| | (ppm) | | (ppm) | | (ppm) | | (ppm) | | (wt %) | |
| | P | B | P | B | P | B | P | B | P | B |
| Example | 2000 | 0 | 1742 | — | 1234 | — | 508 | — | 29.2 | — |
| 2 | | | | | | | | | | |
| Example | 2000 | 1000 | 1677 | 910 | 1201 | 816 | 476 | 94 | 28.4 | 10.3 |
| 7 | | | | | | | | | | |

TABLE 4

| | initial discharge | high-temperature |
|---|---|---|
| | capacity | capacity retention |
| | (mAh/g) | (%, 150 cyc) |
| Example 2 | 227.4 | 76% |
| Example 7 | 225.9 | 80% |

Referring to Tables 3 and 4, in Example 7 where elemental boron was added, the high-temperature capacity retention was improved compared to that from Example 2 having the same input amount of elemental phosphorus.

In Example 7, a residual lithium (LiOH, Li₂CO₃) on the surface of the lithium-transition metal oxide particle and the boron source reacted to form an additional Li—B—O phase on the surface of the particle, thereby further improving ionic conductivity on the surface of the cathode active material.

What is claimed is:

1. A cathode active material for a lithium secondary, comprising:
a lithium-transition metal oxide particle containing phosphorus introduced into the particle; and
a coating formed on at least a portion of a surface of the lithium-transition metal oxide particle, the coating including a phosphorus-containing compound,
wherein a content of phosphorus introduced into the lithium-transition metal oxide particle is in a range from 15 wt % to 30 wt % based on a sum of a weight of phosphorus introduced into the lithium-transition metal oxide particle and a weight of phosphorus contained in the coating.

2. The cathode active material for a lithium secondary battery according to claim 1, wherein the phosphorus-containing compound comprises LiₓP_{y}O_{z} (1≤x≤4, 1≤y≤4, 0≤z≤7).

3. The cathode active material for a lithium secondary battery according to claim 1, wherein the sum of the weight of phosphorus introduced into the lithium-transition metal oxide particle and the weight of phosphorus included in the coating is measured by an inductively coupled plasma emission spectrometry (ICP-OES) analysis of a solution in which the cathode active material is dissolved in an acid solvent.

4. The cathode active material for a lithium secondary battery according to claim 1, wherein the weight of phosphorus included in the coating is measured by the ICP-OES analysis of a solution in which the cathode active material is dissolved in deionized water (DIW) or an organic solvent.

5. The cathode active material for a lithium secondary battery according to claim 1, wherein the weight of phosphorus introduced into the lithium-transition metal oxide particle is in a range from 250 ppm to 700 ppm relative to the total weight of the cathode active material.

6. The cathode active material for a lithium secondary battery according to claim 1, wherein the sum of the weight of phosphorus introduced into the lithium-transition metal oxide particle and the weight of phosphorus included in the coating is in a range from 1,000 ppm to 3,500 ppm relative to the total weight of the cathode active material.

7. The cathode active material for a lithium secondary battery according to claim 1, wherein the lithium-transition metal oxide particle further contains boron, and the coating further includes a boron-containing compound.

8. The cathode active material for a lithium secondary battery according to claim 7, wherein the boron-containing compound comprises a lithium-boron oxide.

9. The cathode active material for a lithium secondary battery according to claim 7, wherein a content of boron included in the lithium-transition metal oxide particle measured by an ICP-OES is in a range from 5 wt % to 20 wt % based on a sum of a weight of boron included in the lithium-transition metal oxide particle and a weight of boron included in the coating.

10. The cathode active material for a lithium secondary battery according to claim 1, further comprising a boundary layer formed between the lithium-transition metal oxide particle and the coating, the boundary layer including the phosphorus-containing compound.

11. The cathode active material for a lithium secondary battery according to claim 10, wherein a weight of phosphorus included in the boundary layer is smaller than the weight of phosphorus included in the coating.

12. A lithium secondary battery, comprising:
a cathode comprising the cathode active material for a lithium secondary battery of claim 1; ands
an anode facing the cathode.

13. A method of preparing a cathode active material for a lithium secondary battery, comprising:
mixing a transition metal precursor, a lithium precursor and a phosphorus source to form a mixture; and
firing the mixture to form a lithium-transition metal oxide particle containing phosphorus introduced into the particle and a coating formed on at least a portion of a surface of the lithium-transition metal oxide particle, the coating containing a phosphorus-containing compound,
wherein a content of phosphorus introduced into the lithium-transition metal oxide particle is in a range from 15 wt % to 30 wt % based on a sum of a weight of phosphorus introduced into the lithium-transition metal oxide particle and a weight of phosphorus contained in the coating measured by an ICP-OES analysis.

14. The method of claim 13, wherein the firing is performed at a temperature of 600° C. to 900° C.

15. The method of claim 13, wherein a phosphorus content in the phosphorus source is in a range from 1,500 ppm to 4,000 ppm based on a total weight of the cathode active material.
